(19) United States
(12) Patent Application Publication
(10) Pub. No.: US 2024/0267064 A1
(43) Pub. Date: Aug. 8, 2024

(54) RADIO FREQUENCY FRONT-END WITH NOISE FILTER

(71) Applicant: Skyworks Solutions, Inc., Irvine, CA (US)

(72) Inventors: John Chi-Shuen Leung, Foothill Ranch, CA (US); David Richard Pehlke, Westlake Village, CA (US)

(21) Appl. No.: 18/430,481

(22) Filed: Feb. 1, 2024

Related U.S. Application Data
(60) Provisional application No. 63/442,860, filed on Feb. 2, 2023.

(51) Int. Cl. H04B 1/00; H04B 1/401

(52) U.S. Cl. CPC H04B 1/0078; H04B 1/401

(57) ABSTRACT

A shared-duplexer front end architecture is configured for operation in either of the 5G new radio n1 band or n65 band, while maintaining low spurious emissions in the adjacent n34 band. A front end module can have a first RF signal processing circuit for receiving RF signals from an antenna, and a second RF signal processing circuit for amplifying and transmitting RF signals via the antenna. The first RF signal processing circuit can be connected to the second RF signal processing circuit via a bypass filter circuit configured to short RF noise (particularly signal components within the n34 band) to the first RF signal processing circuit. The bypass filter circuit can be selectively enabled during transmission by the second RF signal processing circuit to effectively eliminate noise components of the RF signal and reduce spurious emissions in the n34 band.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

Embodiments of the invention relate to electronic systems, and in particular, to radio frequency (RF) electronics.

### Description of Related Technology

RF systems can be used for transmitting and/or receiving signals of a wide range of frequencies. For example, an RF system can be used to wirelessly transmit and receive RF signals in a frequency range of about 30 kilohertz (kHz) to 300 gigahertz (GHz), such as in the range of about 450 megahertz (MHz) to about 7 GHz for certain communications standards.

Examples of RF systems include, but are not limited to, mobile phones, tablets, base stations, network access points, customer-premises equipment (CPE), laptops, and wearable electronics.

### SUMMARY

A front end architecture can be configured for operation in two or more overlapping frequency bands using a shared duplexer, while maintaining low spurious emissions in one or more other bands for coexistence. For example, the front end can include a shared duplexer for uplink in the 5G new radio n1 band and n65 bands, while maintaining low spurious emissions in the n34 band. A notch filter or other type of filter can be positioned between the power amplifier and duplexer to reduce emissions. The filter can be configured to be selectively enabled, e.g., depending on the currently operating uplink band.

For example, in some aspects, the techniques described herein relate to a radio frequency system including: a power amplifier configured to generate an amplified radio frequency transmit signal having a first frequency range when the radio frequency system is configured in a first transmit mode in a first uplink band and having a second frequency range when the radio frequency system is configured in a second transmit mode to transmit in a second uplink band; an uplink filter configured to filter the amplified radio frequency transmit signal, the uplink filter having a passband corresponding to a third frequency range that includes both the first and second frequency ranges; and a noise filter circuit between an output of the power amplifier and the uplink filter, the noise filter configured to filter noise from the amplified radio frequency transmit signal.

In some aspects, the techniques described herein relate to a radio frequency system wherein the noise filter circuit includes a switch and a noise filter, the switch configured to selectively enable and disable the noise filter circuit.

In some aspects, the techniques described herein relate to a radio frequency system wherein the radio frequency system is configured to enable the noise filter circuit when the radio frequency system is operating in the first transmit mode and disable the noise filter circuit when the radio frequency system is operating in the second transmit mode.

In some aspects, the techniques described herein relate to a radio frequency system wherein the switch and the noise filter are in a signal path extending from a first node to ground, the first node being between the output of the power amplifier and the uplink filter.

In some aspects, the techniques described herein relate to a radio frequency system wherein the noise filter implements a notch filter.

In some aspects, the techniques described herein relate to a radio frequency system wherein the noise filter circuit is configured to attenuate radio frequency noise from the amplified radio frequency transmit signal in a passband of the notch filter by at least 10 dBm.

In some aspects, the techniques described herein relate to a radio frequency system wherein the noise filter includes one or more acoustic resonators.

In some aspects, the techniques described herein relate to a radio frequency system wherein the radio frequency system further includes at least one receive path configured to process a radio frequency receive signal received by an antenna, the radio frequency receive signal within a downlink band, and the noise filter circuit is configured to filter noise in the downlink band from the amplified radio frequency transmit signal.

In some aspects, the techniques described herein relate to a radio frequency system wherein the downlink band is adjacent to one or both of the first and second uplink bands.

In some aspects, the techniques described herein relate to a radio frequency system wherein the downlink band is spaced from the first and second uplink bands by no more than about 30 MHz.

In some aspects, the techniques described herein relate to a radio frequency system wherein the first uplink band and the second uplink band are at least partially overlapping.

In some aspects, the techniques described herein relate to a radio frequency system wherein the first uplink band and the second uplink band are both in a range of about 1920 MHz to 2010 MHz, and the noise filter circuit is configured to filter noise emissions in a range of between about 2110 MHz and 2125 MHz.

In some aspects, the techniques described herein relate to a radio frequency system wherein the first uplink band is in a range of about 1920 MHz to 1980 MHz and the second uplink band is in a range of about 1920 MHz to 2010 MHz.

In some aspects, the techniques described herein relate to a radio frequency system wherein the noise filter circuit is configured to maintain spurious emissions in the downlink band below −50 dBm/MHz.

In some aspects, the techniques described herein relate to a radio frequency system wherein the uplink filter is a part of a duplexer configured for frequency division duplexing operation, and the radio frequency system further includes a receive path including a receive amplifier and a downlink filter of the duplexer.

In some aspects, the techniques described herein relate to a radio frequency module including: A substrate; a power amplifier supported by the substrate and configured to generate an amplified radio frequency transmit signal having a first frequency range when the radio frequency module is configured in a first transmit mode in a first uplink band and having a second frequency range when the radio frequency module is configured in a second transmit mode to transmit in a second uplink band; a uplink filter supported by the substrate and configured to filter the amplified radio frequency transmit signal, the uplink filter having a passband corresponding to a third frequency range that includes both the first and second frequency ranges; and a noise filter circuit supported by the substrate and between an output of the power amplifier and the uplink filter, the noise filter circuit configured to filter noise from the amplified radio frequency transmit signal.

In some aspects, the techniques described herein relate to a radio frequency module wherein the noise filter circuit includes a switch and a noise filter, the switch configured to selectively enable and disable the noise filter circuit.

In some aspects, the techniques described herein relate to a radio frequency module wherein the radio frequency module is configured to enable the noise filter circuit when the radio frequency module is operating in the first transmit mode and disable the noise filter circuit when the radio frequency module is operating in the second transmit mode.

In some aspects, the techniques described herein relate to a radio frequency module wherein the switch and the noise filter are in a signal path extending from a first node and ground, the first node being between the output of the power amplifier and the uplink filter.

In some aspects, the techniques described herein relate to a radio frequency module wherein the noise filter implements a notch filter.

In some aspects, the techniques described herein relate to a radio frequency module wherein the noise filter circuit is configured to attenuate radio frequency noise from the amplified radio frequency transmit signal in a passband of the notch filter by at least 10 dBm.

In some aspects, the techniques described herein relate to a radio frequency module wherein the noise filter includes one or more acoustic resonators.

In some aspects, the techniques described herein relate to a radio frequency module wherein the radio frequency module further includes at least one receive path configured to process a radio frequency receive signal received by an antenna, the radio frequency receive signal within a downlink band, and the noise filter circuit is configured to filter noise in the downlink band from the amplified radio frequency transmit signal.

In some aspects, the techniques described herein relate to a radio frequency module wherein the downlink band is adjacent to one or both of the first and second uplink bands.

In some aspects, the techniques described herein relate to a radio frequency module wherein the downlink band is spaced from the first and second uplink bands by no more than about 30 MHz.

In some aspects, the techniques described herein relate to a radio frequency module wherein the first uplink band and the second uplink band are at least partially overlapping.

In some aspects, the techniques described herein relate to a radio frequency module wherein the first uplink band and the second uplink band are both in a range of about 1920 MHz to 2010 MHz, and noise filter circuit filters noise emissions in a range of between about 2110 MHz and 2125 MHz.

In some aspects, the techniques described herein relate to a radio frequency module wherein the first uplink band is in a range of about 1920 MHz to 1980 MHz and the second uplink band is in a range of about 1920 MHz to 2010 MHz

In some aspects, the techniques described herein relate to a radio frequency module wherein the uplink filter is a part of a duplexer configured for frequency division duplexing operation, and the radio frequency module further includes a receive path including a receive amplifier and a downlink filter of the duplexer.

In some aspects, the techniques described herein relate to a radio frequency module wherein the noise filter circuit is configured to maintain spurious emissions in the downlink band below −50 dBm/MHz.

In some aspects, the techniques described herein relate to a mobile device including: an antenna; and a radio frequency system or radio frequency module of any of the preceding claims.

### BRIEF DESCRIPTION OF THE DRAWINGS

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of an example dual connectivity network topology.

FIG. 5A is a schematic diagram of a front end module according to one embodiment.

FIG. 5B is a schematic diagram of a front end module according to an additional embodiment.

FIG. 5C is a schematic diagram of another embodiment of a front end module.

FIG. 6 is a schematic diagram of a radio frequency (RF) system including a front end module according any one of FIGS. 5A-5C.

FIG. 7 is a diagram showing one example of simulation results of transmission by a front end module.

FIG. 8 is a schematic diagram of one embodiment of a mobile device.

FIG. 9A is a schematic diagram of one embodiment of a packaged module.

FIG. 9B is a schematic diagram of a cross-section of the packaged module of FIG. 9A taken along the lines 9B-9B.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IoT), Vehicle-to-Everything (V2X), and High Power User Equipment (HPUE).

3GPP introduced Phase 1 of fifth generation (5G) technology in Release 15, and introduced Phase 2 of 5G technology in Release 16. Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

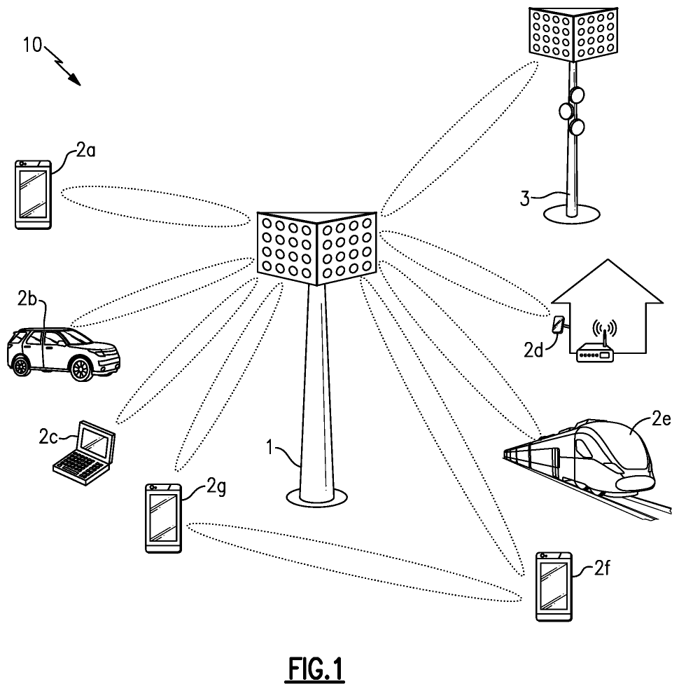

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi. Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul (for instance, as between mobile device 2g and mobile device 2f).

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz.

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

In certain implementations, the communication network 10 supports supplementary uplink (SUL) and/or supplementary downlink (SDL). For example, when channel conditions are good, the communication network 10 can direct a particular UE to transmit using an original uplink frequency, while when channel condition is poor (for instance, below a certain criteria) the communication network 10 can direct the UE to transmit using a supplementary uplink frequency that is lower than the original uplink frequency. Since cell coverage increases with lower frequency, communication range and/or signal-to-noise ratio (SNR) can be increased using SUL. Likewise, SDL can be used to transmit using an original downlink frequency when channel conditions are good, and to transmit using a supplementary downlink frequency when channel conditions are poor.

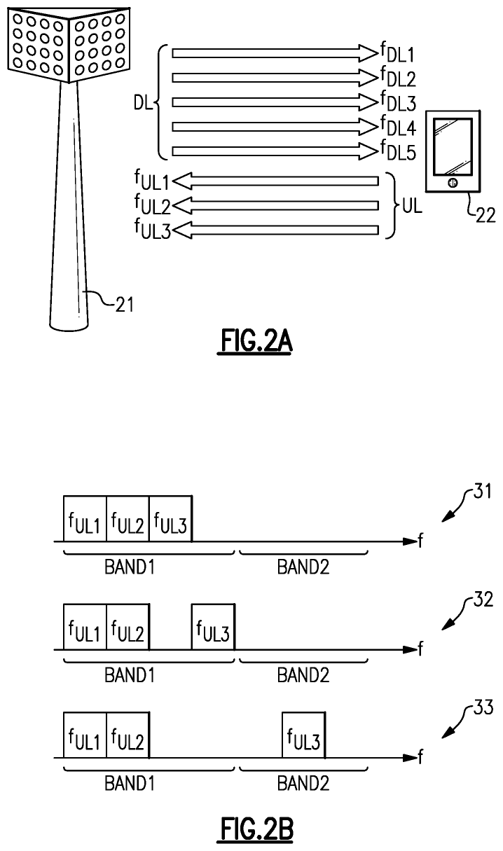

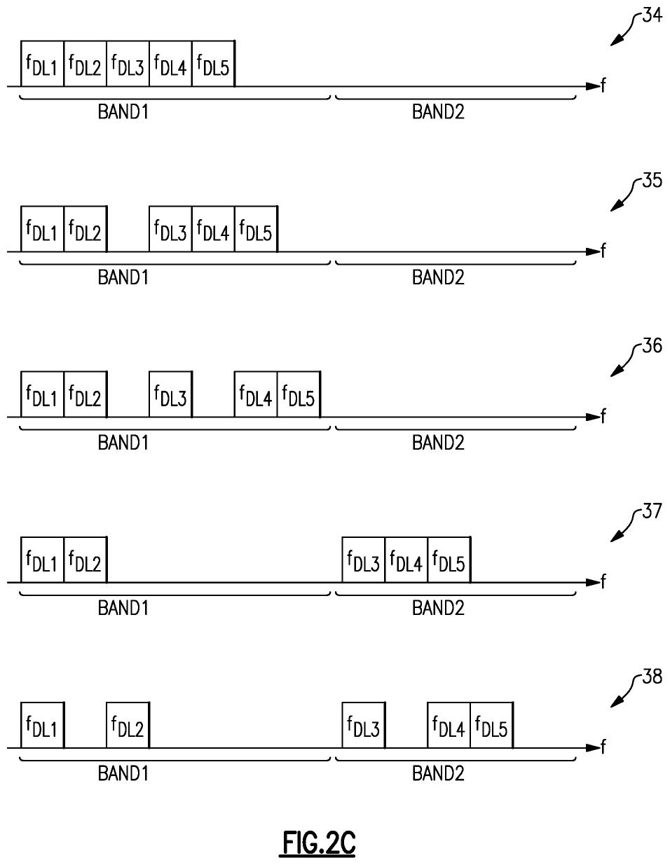

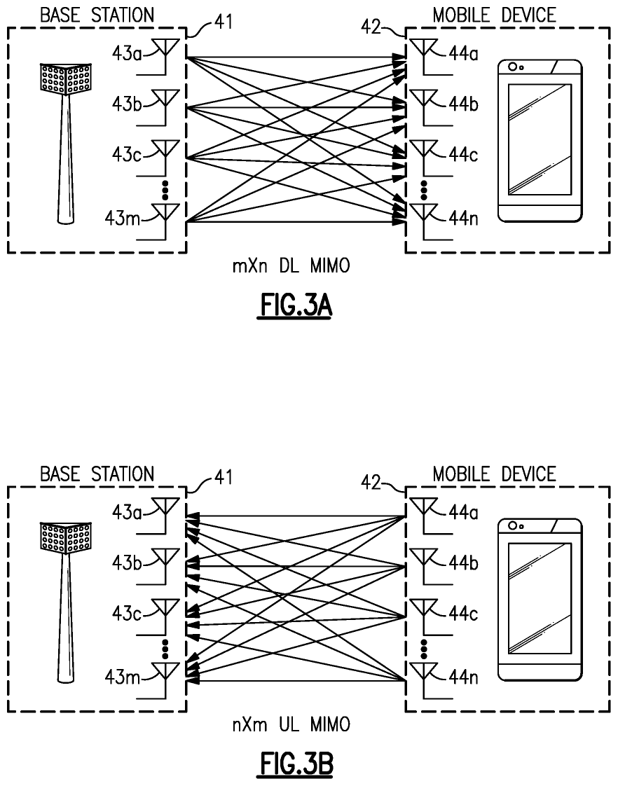

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL4}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and secondary cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink.

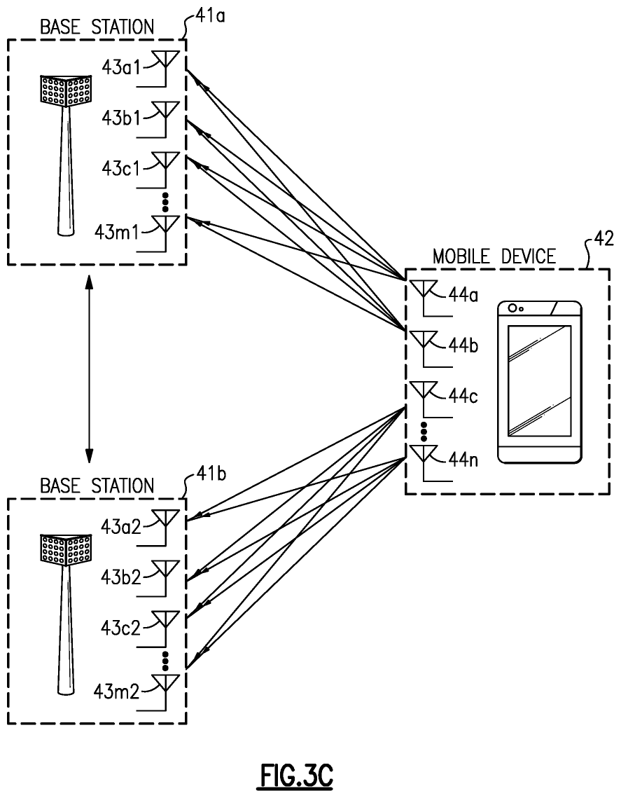

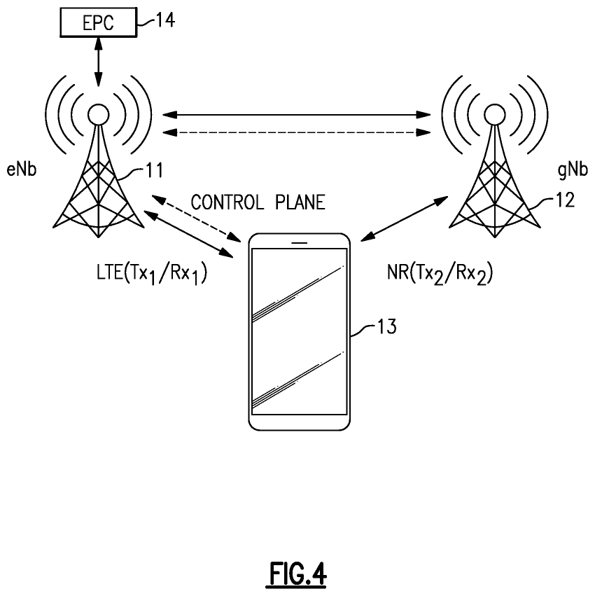

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additional a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

With the introduction of the 5G NR air interface standards, 3GPP has allowed for the simultaneous operation of 5G and 4G standards in order to facilitate the transition. This mode can be referred to as Non-Stand-Alone (NSA) operation or E-UTRAN New Radio-Dual Connectivity (EN-DC) and involves both 4G and 5G carriers being simultaneously transmitted from a user equipment (UE).

In certain EN-DC applications, dual connectivity NSA involves overlaying 5G systems onto an existing 4G core network. For dual connectivity in such applications, the control and synchronization between the base station and the UE can be performed by the 4G network while the 5G network is a complementary radio access network tethered to the 4G anchor. The 4G anchor can connect to the existing 4G network with the overlay of 5G data/control.

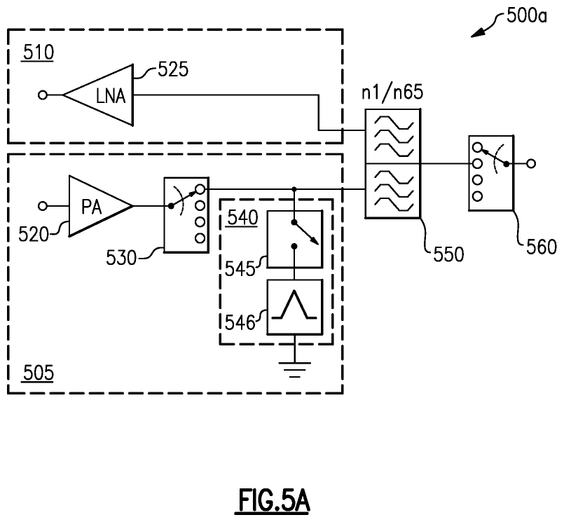

FIG. 4 is a schematic diagram of an example dual connectivity network topology. This architecture can leverage LTE legacy coverage to ensure continuity of service delivery and the progressive rollout of 5G cells. A UE 13 can simultaneously transmit dual uplink LTE and NR carriers. The UE 13 can transmit an uplink LTE carrier Tx₁ to the eNB 11 while transmitting an uplink NR carrier Tx₂ to the gNB 12 to implement dual connectivity. Any suitable combination of uplink carriers Tx₁, Tx₂ and/or downlink carriers Rx₁, Rx₂ can be concurrently transmitted via wireless links in the example network topology. The eNB 11 can provide a connection with a core network, such as an Evolved Packet Core (EPC) 14. The gNB 12 can communicate with the core network via the eNB 11. Control plane data can be wireless communicated between the UE 13 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 13. With a TDD LTE anchor point, network operation may be synchronous, in which case the operating modes can be constrained to Tx₁/Tx₂ and Rx₁/Rx₂, or asynchronous which can involve Tx₁/Tx₂, Tx₁/Rx₂, Rx₁/Tx₂, Rx₁/Rx₂. When the LTE anchor is a frequency division duplex (FDD) carrier, the TDD/FDD inter-band operation can involve simultaneous Tx₁/Rx₁/Tx₂ and Tx₁/Rx₁/Rx₂.

As discussed above, EN-DC can involve both 4G and 5G carriers being simultaneously transmitted from a UE. Transmitting both 4G and 5G carriers in a UE, such as a phone, typically involves two power amplifiers (PAs) being active at the same time. Traditionally, having two power amplifiers active simultaneously would involve the placement of one or more additional power amplifiers specifically suited for EN-DC operation. Additional board space and expense is incurred when designing to support such EN-DC/NSA operation.

### Shared-Duplexer Front End Architecture

Modern RF systems often communicate using one or more communication standards such as 4G LTE, 5G, and/or WiFi. One communication standard can specify communication over a frequency band that is relatively close in proximity to and/or overlapping in frequency with another frequency band, or with a frequency band of a different communication standard. RF systems disclosed herein can include a shared-duplexer front end architecture capable of supporting a frequency range covering two or more proximal uplink bands, while allowing for coexistence with at least one downlink band, e.g., where the downlink band is adjacent or spaced relatively close to the uplink bands.

As an example, an RF front end module (FEM) can be implemented to transmit over a frequency range of about 1920 MHz to 2010 MHz and receive signals over a frequency range of about 2110 MHz to 2200 MHz, thereby supporting handling of RF uplink signals in both the 5G NR band n1 and band n65.

In one example, 5G NR band n1 operates over an uplink frequency range of about 1920 MHz to 1980 MHz, while 5G NR band n65 operates over an uplink frequency range of about 1920 MHz to 2010 MHz. Similarly, band n1 operates over a downlink frequency range of about 2110 MHz to 2170 MHz, while band n65 operates over a downlink frequency range of about 2110 MHz to 2200 MHz. In this case, 5G NR communication standards dictate that user equipment operable in bands n1 or n65 support frequency division duplexing (FDD) as discussed herein.

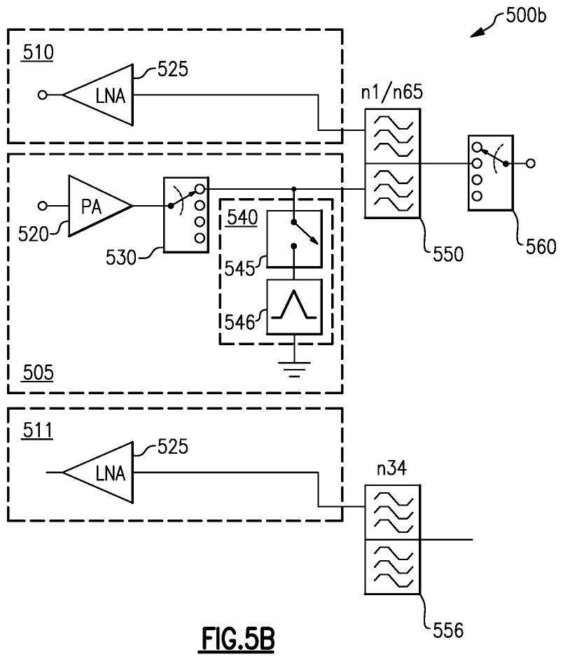

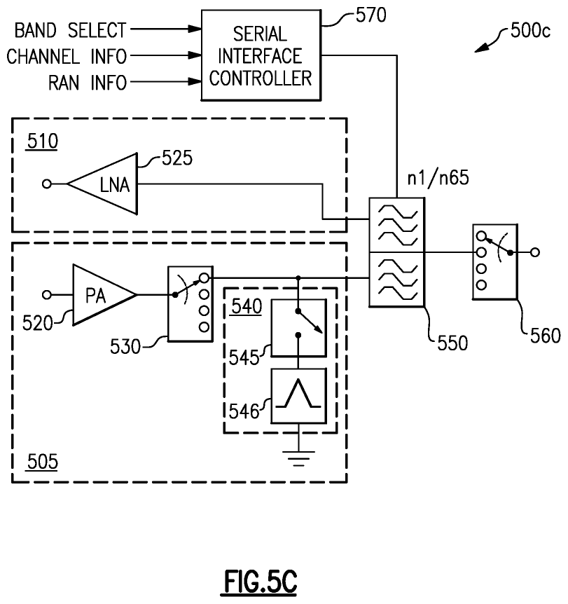

FIG. 5A is a schematic diagram of an RF front end module (FEM) 500a. The RF FEM 500a comprises a transmit (TX) circuit 505 and a receive (RX) circuit 510 operably connected to an RF duplexer 550 having a downlink filter (top) and uplink filter (bottom) and which supports FDD operation in the 5G NR n1 and n65 bands. The RF duplexer 550 is connected to one or more antennas (not shown) by way of an antenna switch 560. The antenna switch 560 can be a single-pole, multi-throw (SPMT) switch configured to switch the antenna connection of the RF duplexer 550, e.g., between antennas of an antenna array. In other embodiments, several RF FEMs 500a supporting different frequency bands may share a single antenna connection via the antenna switch 560.

The transmit circuit 505 of the FEM 500a includes a transmit power amplifier 520 connected to a transmit switch 530 (such as another SPMT switch), which is in turn connected to the uplink portion of the duplexer 550. A noise filter circuit 540 is connected between the transmit switch 530 and the duplexer 550. The TX switch 530 can be switched to divert an output RF signal of the TX power amplifier 520 to bypass the duplexer 550 and/or connect the power amplifier 520 to another transmit path or other connection.

The receive circuit 510 connected to the downlink portion of the duplexer 550 includes at least a receive amplifier 525 configured to amplify incoming RF signals from the duplexer. The receive amplifier 525 is preferably a low-noise amplifier (LNA). The receive circuit 510 can further include signal conditioning or filtering stages to improve receive sensitivity and/or selectivity. For example, the receive circuit 510 can include a tunable filter configured to reject RF noise from the adjacent transmit circuit 505.

The duplexer 550 can filter transmitted and received RF signals, and allows the TX circuit 505 and the RX circuit 510 to share a single connected antenna via the antenna switch 560, and can provide for frequency division duplex (FDD) operation. In certain embodiments, the antenna switch 560 is configured to switch the RF FEM 500a between a plurality of antennas to support MIMO communication. The TX switch 530 can also be directly connected to the antenna switch 560 to selectively bypass the TX filter circuit 540 and duplexer 550, allowing the RF FEM 500a to support additional operating modes.

The TX filter circuit 540 can include a single-pole, single-throw (SPST) switch 545 and an RF filter 546. The RF filter 546 can be a surface acoustic wave (SAW) filter, bulk acoustic wave (BAW) filter, or inductor-capacitor (LC) resonant filter. For instance, the RF filter 546 can be a notch filter (configured as a band-pass filter) having a pass band complementary to certain operating frequencies of the front end module 500a. For example, the RF FEM 500a supporting the 5G NR n1 band and n65 band can be connected to a signal source (such as an RF modulator) capable of producing RF signals in the range of approximately 2110 MHz to 2200 MHz. When the RF FEM 500a is transmitting via the TX circuit 505 between 1920 MHz and 1980 MHz (corresponding to the 5G n1 band), spurious emissions may be produced between 2010 MHz and 2025 MHz in the new radio n34 band.

To mitigate such spurious emissions and improve coexistence with n34 downlink operation of a mobile device including the RF FEM 500a, the RF filter 546 can have a pass band corresponding to neighboring frequencies of the first and second uplink frequency bands. For example, band n34 spurious emissions can be corrected by a notch filter 546 configured to filter primarily n34 band downlink frequency range (e.g., 2010 MHz through 2025 MHz). During transmission by the TX circuit 505, the SPST switch 545 can be selectively enabled to form a ground path through the TX filter circuit 540 that couples RF signal components in the n34 downlink frequency range to a circuit ground.

In the example implementation, the SPST switch 545 can be enabled (closed) specifically when the radio frequency module 500a is operating in an uplink mode where it is transmitting in the n1 band, between 1920 MHz and 1980 MHz. Enabling the filter circuit 540 can allow for spurious emissions in the n34 band to be maintained below −50 dBm/MHz, e.g., improving coexistence with n34 downlink operation by a mobile device including the radio frequency module 500a. Conversely, in the example implementation, when the radio frequency module 500a is operating in an uplink mode where it is transmitting in the n65 band, between 1980 MHz and 2010 MHz, the SPST switch 545 can be disabled (open) to electrically disconnect the TX filter 546 and ground path from the TX circuit 505. In certain embodiments, the SPST switch 545 can be replaced with another SPMT switch configured to select between a plurality of RF TX filters 546 (such as notch filters, band-pass filters, or high or low-pass filters) to selectively enable filtering of various frequency bands. In some other embodiments the switch 540 is excluded and the filter operates during both n1 and n65 uplink modes.

FIG. 5B is a schematic diagram of an RF front end system 500b according to an additional embodiment. The RF front end system 500b includes a first receive circuit 510 and a transmit circuit 505, which can be similar to or the same as those of FIG. 5A. The RF front end system 500b of FIG. 5B also shows a second receive circuit 511 coupled to a downlink filter portion of a second duplexer 556. For example, the second receive circuit 511 and duplexer 556 can be configured to process signals received in the n34 downlink band, between 2110 MHz and 2125 MHz. The second receive circuit 511 and/or second duplexer 556 may exist on the same module as the first receive circuit 510, the transmit circuit 505, and/or the first duplexer 550. Or, in other embodiments, the second receive circuit 511 and/or second duplexer 556 may exist on a different module but on the same mobile device as the first receive circuit 510, the transmit circuit 505, and the first duplexer 550. For example, the first duplexer 550 may be connected via the switch 560 to a first antenna of the mobile device, while the second duplexer 556 may be connected to a second antenna of the mobile device.

The noise filter circuit 540 of the transmit circuit 505 can reduce spurious emissions by the transmit circuit 505 in the n34 band, thereby reducing noise received by the second duplexer 556 and/or the second receive circuit 511, improving band coexistence, e.g., during simultaneous n1 uplink and n34 downlink operation.

FIG. 5C shows another embodiment of an RF FEM 500c, which includes the TX circuit 505 and RX circuit 510 connected by the duplexer 550 similarly to the RF FEM 500a. The RF FEM 500c of FIG. 5C further includes a serial interface controller 570 configured to tune one or more tunable filters of the duplexer 550. The serial interface controller 570 can be a mobile industry processor interface (MIPI) controller connected to one or more of the duplexer 550, TX switch 530, and/or antenna switch 560. Although one embodiment is shown, the RF FEM 500b can be further modified to include any of the RF processing circuits as shown herein.

With continuing reference to FIG. 5C, the serial interface controller 570 can tune one or more tunable filters of the duplexer 550 and/or alternate the switches 530/560 based on system level information, such as band information (BAND SELECT), channel information (CHANNEL INFO), and/or radio access network information (RAN INFO). The serial interface controller 570 can receive system level information from a transceiver and control one or more components of the RF FEM 550c as discussed above in accordance with communication standards of the operating band(s).

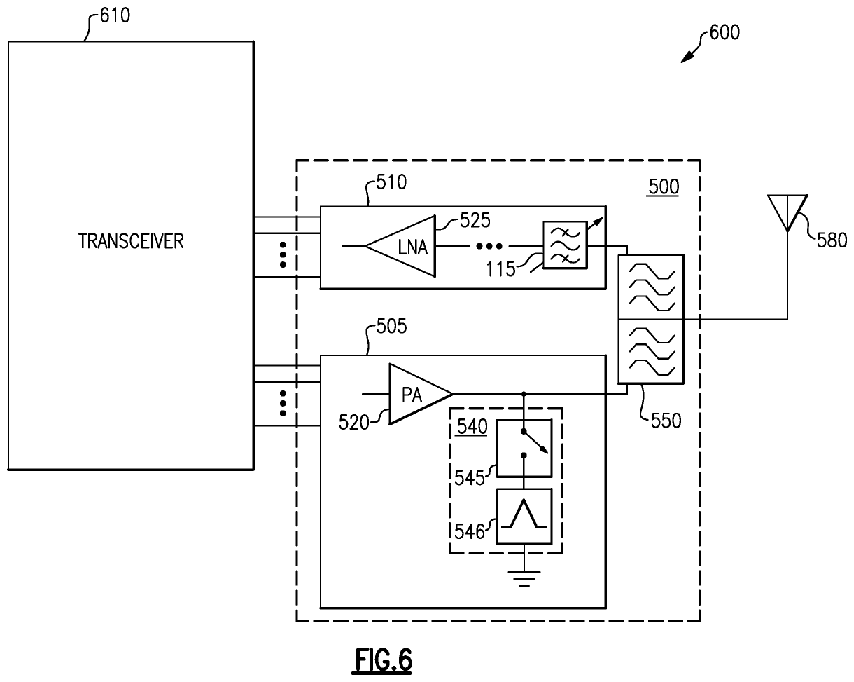

FIG. 6 is a schematic diagram of one embodiment of an RF system 600. The RF system 600 includes a transceiver 610, a first antenna 580, and an RF front end module 500 according to any of FIGS. 5A-5C. Although FIG. 6 illustrates one embodiment of an RF system, the teachings herein are applicable to RF systems implemented in a wide variety of ways.

The RF FEM 500 can provide a number of functionalities associated with, for example, MIMO communications, switching between different bands, carrier aggregation, switching between different power modes, filtering of signals, duplexing of signals, and/or some combination thereof. In the illustrated embodiment, the RF FEM 500 includes a transmit circuit 505, a receive circuit 510, a noise filter circuit 540, and a duplexer 550.

As shown in FIG. 6, the receive circuit 510 can include the tunable filter 115 and low noise amplifier (LNA) 525 for amplifying a filtered signal received from the antenna 580. Signal filtering can also be provided by one or more filters of the duplexer 550. In certain implementations, the receive circuit 510 is implemented on a module, for instance, a multi-chip module (MCM). Although illustrated as including the tunable filter 115 and the LNA 525, other implementations of the receive circuit 510 are possible, such as configurations including additional components, for instance, one or more switches, one or more power amplifiers, and/or other circuitry.

The transmit circuit 505 includes the power amplifier 520 and noise filter circuit 540, which provide a first amplified and filtered RF signal to the first antenna 580 via the duplexer 550. Although illustrated as including the power amplifier 520 and filter 540, the transmit circuit 505 can include additional components (e.g., the transmit switch 530 and/or additional filtering stages). In certain implementations, the transmit circuit 505 can also be implemented on a module, for instance, an MCM.

The noise filter circuit 540 provides a switchable ground path from the power amplifier 520 to short RF noise. The noise filter circuit 540 can be selectively enabled (i.e., the SPST switch 545 closed) during transmissions by the transmit circuit 505 to effectively eliminate noise components of the RF signal from the transceiver 610 and reduce spurious emissions within specific frequency bands.

As shown in FIG. 6, the RF FEM 500 is connected to the transceiver 610 by various connections, which can include one or more RF signal routes to the transmit circuit 505 and the receive circuit 510. In certain implementations, the connections further include a digital interface, such as a mobile industry processor interface radio frequency front end (MIPI RFFE) bus, an inter-integrated circuit (I²C) bus, and/or other suitable interfaces.

In the illustrated embodiment, the receive circuit 510 is implemented to support reception of a first downlink frequency band and a second downlink frequency band of a communication standard. In one embodiment, the first downlink frequency band can correspond to the 5G NR n1 band (approximately 2110 MHz to 2170 MHz) and the second downlink frequency band can correspond to the 5G NR n65 band (approximately 2110 MHz to 2200 MHz). The receive circuit 510 can include the tunable filter 115 having adjustable bandwidth to control an amount of filtering provided before a received signal is amplified by the LNA 525. Alternatively, signal filtering can be provided at least in part by the duplexer 550.

Conversely, the transmit circuit 505 is configured to transmit an RF signal of a first uplink frequency band or a second uplink frequency band of the communication standard. For example, the first uplink frequency band can correspond to the 5G NR n1 band (approximately 1920 MHz to 1980 MHz) and the second uplink frequency band can correspond to the 5G NR n65 band (approximately 1920 MHz to 2010 MHz).

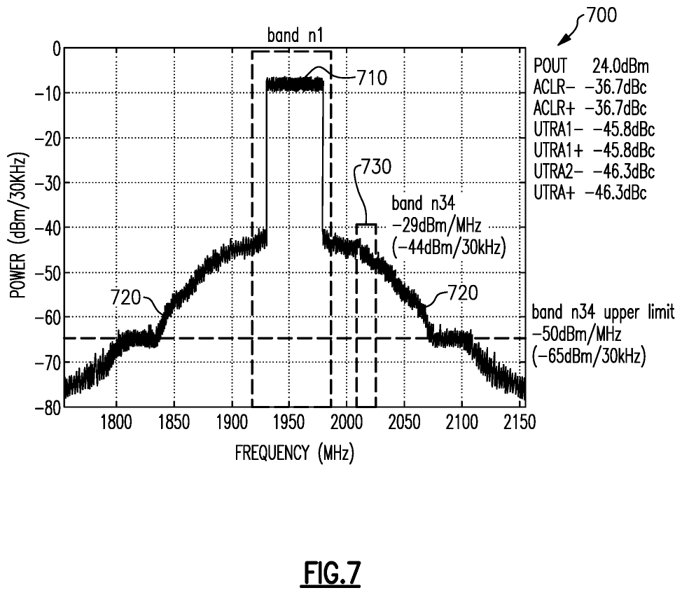

FIG. 7 is a diagram showing a simulation of power spectral density for a RF FEM without a noise filter circuit 540. A graph 700 of power spectral density illustrates the behavior of one implementation of the front end module when configured to transmit in 5G NR band n1 (approximately 1920 MHz to 1980 MHz).

For the illustrated embodiment, power spectral density in a region 710 centered around a transmit frequency of 1955 MHz is stable around −10 dBm/30 kHz. In a pair of peripheral regions 720 above about 1980 MHz and below about 1930 MHz, power spectral density falls off nonlinearly. In a region of the graph 730 corresponding to 5G NR band n34 (2010 MHz to 2025 MHz), power spectral density (representative of spurious emissions in the n34 band) can be measured at about −29 dBm/30 kHz. Communication standards, such as those set by the 3GPP, dictate that spurious emissions in the n34 band should not exceed −50 dBm/MHz (−65 dBm/30 kHz) during transmissions in the n1 band. In order to narrow the range of frequencies for which power spectral density exceeds −50 dBm/MHz, RF front-end modules according to any of FIGS. 5A-6 include the noise filter circuit 540 to selectively enable the RF filter 546 and couple spurious emissions to ground.

### Mobile Device and RF Front-End System

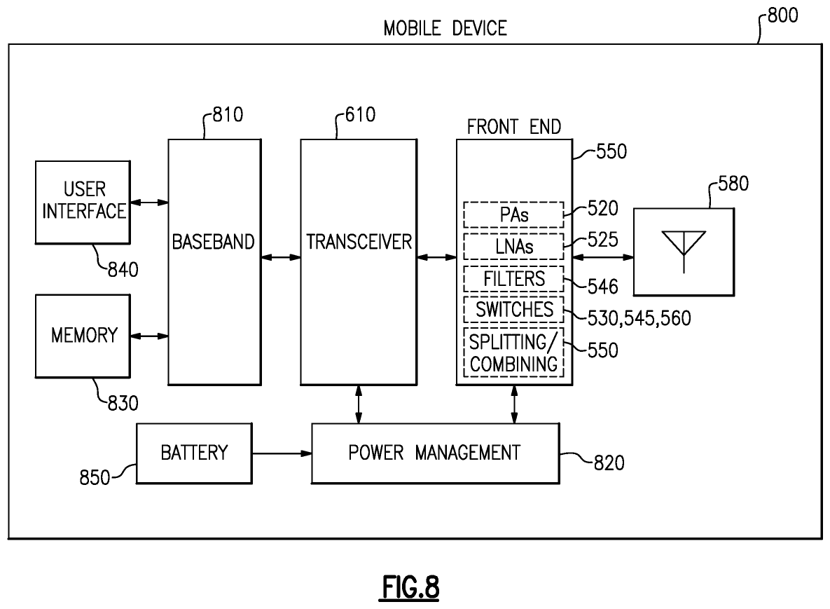

FIG. 8 is a schematic diagram of one embodiment of a mobile device 800 implementing the front end architecture as described here. The mobile device 800 includes a front-end module 550, a first antenna 580, a transceiver 610, a baseband system 810, a power management system 820, a memory 830, a user interface 840, and a battery 850.

The mobile device 800 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 610 generates RF signals for transmission and processes incoming RF signals received from one or more antennas, including the first antenna 580. It will be understood that various functionalities associated with the transmission and receiving of RF signals can be achieved by one or more components that are collectively represented in FIG. 8 as the transceiver 610. In one example, separate components (for instance, separate circuits or dies) can be provided for handling certain types of RF signals.

The RF FEM 500 aids in conditioning signals transmitted to and/or received from the first antenna 580 as discussed herein with reference to FIG. 5-7. In the illustrated embodiment, the RF FEM 500 includes one or more power amplifiers (PAS) 520, low noise amplifiers (LNAs) 525, filters 546, switches (including the various switches 530, 545, and 560 as illustrated in FIG. 5A), and signal splitting/combining circuitry (such as the duplexer 550). However, other implementations are possible.

For example, the RF FEM 500 can provide a number of functionalities, including, but not limited to, amplifying signals for transmission, amplifying received signals, filtering signals, switching between different bands, switching between different power modes, switching between transmission and receiving modes, duplexing of signals, multiplexing of signals, or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antenna 580 can include one or more antennas used for a wide variety of types of communications. For example, the first antenna 580 can include an antenna for transmitting and/or receiving signals associated with a wide variety of frequencies and communications standards.

In certain implementations, a plurality of antennas can support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, the antenna switch 560 can be used to select a particular antenna from the plurality of antennas based on a variety of factors, such as an observed bit error rate and/or a signal strength indicator.

The mobile device 800 can operate with beamforming in certain implementations. For example, the RF FEM 500 can include amplifiers having controllable gain and phase shifters having controllable phase to provide beam formation and directivity for transmission and/or reception of signals using the antennas. For example, in the context of signal transmission, the amplitude and phases of the transmit signals provided to each of the plurality of antennas are controlled such that radiated signals combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas from a particular direction. In certain implementations, the first antenna 580 can include one or more arrays of antenna elements to enhance beamforming.

The baseband system 810 is coupled to the user interface 840 to facilitate processing of various user input and output (I/O), such as voice and data. The baseband system 810 provides the transceiver 610 with digital representations of transmit signals, which the transceiver 610 processes to generate RF signals for transmission. The baseband system 810 also processes digital representations of received signals provided by the transceiver 610. As shown in FIG. 8, the baseband system 810 is coupled to the memory 830 to facilitate operation of the mobile device 800.

The memory 830 can be used for a wide variety of purposes, such as storing data and/or instructions to facilitate the operation of the mobile device 800 and/or to provide storage of user information.

The power management system 820 provides a number of power management functions of the mobile device 800. In certain implementations, the power management system 820 includes a PA supply control circuit that controls a supply voltage of each of the power amplifiers 520/525. For example, the power management system 820 can be configured to change the supply voltage(s) provided to one or more of the power amplifiers 520 to improve efficiency, such as power added efficiency (PAE). The power management system 820 can include PMUs implemented in accordance with the teachings herein. Thus, the power management system 820 can be implemented in accordance with any of the embodiments herein, and serves as a power management sub-system for UE.

As shown in FIG. 8, the power management system 820 receives a battery voltage from the battery 850. The battery 850 can be any suitable battery for use in the mobile device 800, including, for example, a lithium-ion battery.

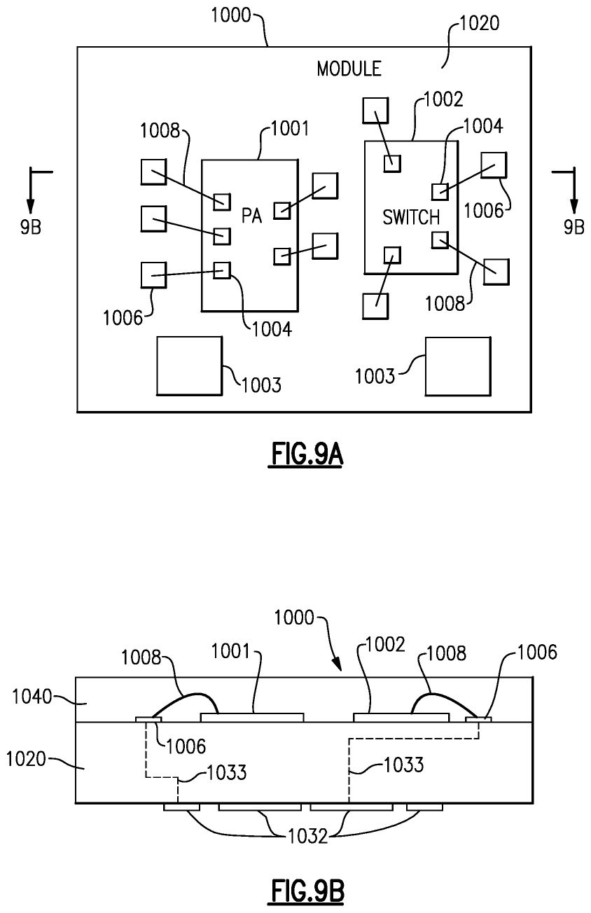

FIG. 9A is a schematic diagram of one embodiment of a packaged module 1000, and can implement any of the modules described herein, including those shown and described with respect to FIGS. 5A-7. FIG. 9B is a schematic diagram of a cross-section of the packaged module 1000 of FIG. 9A taken along the lines 9B-9B.

The packaged module 1000 includes a power amplifier die 1001, a supply switch die 1002, surface mount components 1003, wirebonds 1008, a package substrate 1020, and encapsulation structure 1040. The package substrate 1020 includes pads 1006 formed from conductors disposed therein. Additionally, the dies 1001, 1002 include pads 1004, and the wirebonds 1008 have been used to connect the pads 1004 of the dies 1001, 1002 to the pads 1006 of the package substrate 1020.

The power amplifier die 1001 and the supply switch die 1002 are implemented in accordance with one or more features of the present disclosure. In certain implementations, the supply switch die 1002 provides a selected power amplifier supply voltage to the power amplifier die 1001.

In certain implementations, the dies 1001, 1002 are manufactured using different processing technologies. In one example, the power amplifier die 1001 is manufactured using a heterojunction bipolar transistor (HBT) process, and the supply switch die 1002 is manufactured using a silicon process.

The packaging substrate 1020 can be configured to receive a plurality of components such as the dies 1001, 1002 and the surface mount components 1003, which can include, for example, surface mount capacitors and/or inductors.

As shown in FIG. 9B, the packaged module 1000 is shown to include a plurality of contact pads 1032 disposed on the side of the packaged module 1000 opposite the side used to mount the dies 1001, 1002. Configuring the packaged module 1000 in this manner can aid in connecting the packaged module 1000 to a circuit board such as a phone board of a wireless device. The example contact pads 1032 can be configured to provide RF signals, bias signals, power low voltage(s) and/or power high voltage(s) to the dies 1001, 1002 and/or the surface mount components 1003. As shown in FIG. 9B, the electrically connections between the contact pads 1032 and the die 1001 can be facilitated by connections 1033 through the package substrate 1020. The connections 1033 can represent electrical paths formed through the package substrate 1020, such as connections associated with vias and conductors of a multilayer laminated package substrate.

In some embodiments, the packaged module 1000 can also include one or more packaging structures to, for example, provide protection and/or facilitate handling of the packaged module 1000. Such a packaging structure can include overmold or encapsulation structure 1040 formed over the packaging substrate 1020 and the components and die(s) disposed thereon.

It will be understood that although the packaged module 1000 is described in the context of electrical connections based on wirebonds, one or more features of the present disclosure can also be implemented in other packaging configurations, including, for example, flip chip configurations.

### Applications

Some of the embodiments described above have provided examples in connection with mobile devices. However, the principles and advantages of the embodiments can be used for any other systems or apparatus that have needs for UHB architectures. Examples of such RF communication systems include, but are not limited to, mobile phones, tablets, base stations, network access points, customer-premises equipment (CPE), laptops, and wearable electronics.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A radio frequency system comprising:
a power amplifier configured to generate an amplified radio frequency transmit signal having a first frequency range when the radio frequency system is configured in a first transmit mode in a first uplink band and having a second frequency range when the radio frequency system is configured in a second transmit mode to transmit in a second uplink band;
an uplink filter configured to filter the amplified radio frequency transmit signal, the uplink filter having a passband corresponding to a third frequency range that includes both the first and second frequency ranges; and
a noise filter circuit between an output of the power amplifier and the uplink filter, the noise filter circuit configured to filter noise from the amplified radio frequency transmit signal.

2. The radio frequency system of claim 1 wherein the noise filter circuit includes a switch and a noise filter, the switch configured to selectively enable and disable the noise filter circuit.

3. The radio frequency system of claim 2 wherein the radio frequency system is configured to enable the noise filter circuit when the radio frequency system is operating in the first transmit mode and disable the noise filter circuit when the radio frequency system is operating in the second transmit mode.

4. The radio frequency system of claim 2 wherein the switch and the noise filter are in a signal path extending from a first node to ground, the first node being between the output of the power amplifier and the uplink filter.

5. The radio frequency system of claim 4 wherein the noise filter implements a notch filter.

6. The radio frequency system of claim 5 wherein the noise filter circuit is configured to attenuate radio frequency noise from the amplified radio frequency transmit signal in a passband of the notch filter by at least 10 dBm.

7. The radio frequency system of claim 4 wherein the noise filter includes one or more acoustic resonators.

8. The radio frequency system of claim 1 wherein the radio frequency system further includes at least one receive path configured to process a radio frequency receive signal received by an antenna, the radio frequency receive signal within a downlink band, and the noise filter circuit is configured to filter noise in the downlink band from the amplified radio frequency transmit signal.

9. The radio frequency system of claim 8 wherein the downlink band is adjacent to one or both of the first and second uplink bands.

10. The radio frequency system of claim 8 wherein the downlink band is spaced from the first and second uplink bands by no more than about 30 MHz.

11. The radio frequency system of claim 8 wherein the first uplink band and the second uplink band are at least partially overlapping.

12. The radio frequency system of claim 8 wherein the noise filter circuit is configured to maintain spurious emissions in the downlink band below −50 dBm/MHz.

13. A radio frequency module comprising:
a substrate;
a power amplifier supported by the substrate and configured to generate an amplified radio frequency transmit signal having a first frequency range when the radio frequency module is configured in a first transmit mode in a first uplink band and having a second frequency range when the radio frequency module is configured in a second transmit mode to transmit in a second uplink band;
a uplink filter supported by the substrate and configured to filter the amplified radio frequency transmit signal, the uplink filter having a passband corresponding to a third frequency range that includes both the first and second frequency ranges; and
a noise filter circuit supported by the substrate and between an output of the power amplifier and the uplink filter, the noise filter circuit configured to filter noise from the amplified radio frequency transmit signal.

14. The radio frequency module of claim 13 wherein the noise filter circuit includes a switch and a noise filter, the switch configured to selectively enable and disable the noise filter circuit.

15. The radio frequency module of claim 14 wherein the radio frequency module is configured to enable the noise filter circuit when the radio frequency module is operating in the first transmit mode and disable the noise filter circuit when the radio frequency module is operating in the second transmit mode.

16. The radio frequency module of claim 14 wherein the switch and the noise filter are in a signal path extending from a first node and ground, the first node being between the output of the power amplifier and the uplink filter.

17. The radio frequency module of claim 16 wherein the noise filter implements a notch filter.

18. The radio frequency module of claim 17 wherein the noise filter circuit is configured to attenuate radio frequency noise from the amplified radio frequency transmit signal in a passband of the notch filter by at least 10 dBm.

19. The radio frequency module of claim 14 wherein the radio frequency module further includes at least one receive path configured to process a radio frequency receive signal received by an antenna, the radio frequency receive signal within a downlink band, and the noise filter circuit is configured to filter noise in the downlink band from the amplified radio frequency transmit signal.

20. A mobile device comprising:
an antenna; and
a radio frequency system coupled to the antenna and including a power amplifier configured to generate an amplified radio frequency transmit signal having a first frequency range when the radio frequency system is configured in a first transmit mode in a first uplink band and having a second frequency range when the radio frequency system is configured in a second transmit mode to transmit in a second uplink band, the radio frequency system including an uplink filter configured to filter the amplified radio frequency transmit signal, the uplink filter having a passband corresponding to a third frequency range that includes both the first and second frequency ranges, the radio frequency system further including a noise filter circuit between an output of the power amplifier and the uplink filter, the noise filter circuit configured to filter noise from the amplified radio frequency transmit signal.
